(19) United States
(12) Patent Application Publication
(10) Pub. No.: US 2025/0039846 A1
(43) Pub. Date: Jan. 30, 2025

(54) DIRECTION AWARE RADIO RESOURCE SELECTION FOR DIRECT COMMUNICATION BETWEEN WIRELESS DEVICES

(71) Applicant: Nokia Technologies Oy, Espoo (FI)

(72) Inventors: Daniel MEDINA, Munich (DE); Prajwal KESHAVAMURTHY, Munich (DE); Ali KARIMIDEHKORDI, Munich (DE); Amir Mehdi AHMADIAN TEHRANI, Munich (DE); Alessio MARCONE, Munich (DE); Torsten WILDSCHEK, Gloucester (GB)

(21) Appl. No.: 18/716,230

(22) PCT Filed: Dec. 22, 2021
(86) PCT No.: PCT/EP2021/087284

§ 371 Date: Jun. 4, 2024

(51) Int. Cl. H04W 72/02; H04W 16/28; H04W 28/26; H04W 72/40

(52) U.S. Cl. CPC H04W 72/02; H04W 16/28; H04W 28/26; H04W 72/40

(57) ABSTRACT

According to an example aspect of the present invention, there is provided a method for a first device, comprising: receiving a first radio transmission from a third device; determining, based on the received first radio transmission, at least one radio resource expected to be used for communication by the third device; determining a first direction from which the first radio transmission from the third device is received at the first device; determining a radio resource set based on the determined at least one radio resource and the determined first direction; and selecting one or more radio resources from the determined radio resource set for communication with a second device or transmitting the determined radio resource set to the second device or a network entity.

### FIELD

Various example embodiments relate to radio resource selection for wireless devices, and in particular for direct communication scenarios between terminal devices.

### BACKGROUND

There is an ongoing effort in the Third Generation Partnership Project (3GPP) to support advanced Vehicle-to-Everything (V2X) services (e.g., sensor sharing, platooning, etc.), and this has motivated the standardization in Rel-16 of New Radio (NR) sidelink for direct communication between user equipments (UEs) (e.g., vehicles, road infrastructure, and other devices). In order to achieve higher data rates in the sidelink, higher frequencies above 6 GHZ (so-called millimeter waves) have been considered by 3GPP. In order to compensate for the higher path loss of the radio channel and ensure good coverage, multi-panel devices equipped with a high number of antennas and advanced beamforming techniques are envisioned as a key technology for the future releases of NR sidelink and are expected to be part of Rel-18. Apart from coverage extension, beamforming steers the signal transmission/reception towards the intended receiver/transmitter (e.g., in a unicast sidelink transmission), thus avoiding interference to/from other UEs. This allows for higher spatial reuse and leads to increased data throughput on both link and system levels.

### SUMMARY

According to some aspects, there is provided the subject matter of the independent claims. Some embodiments for some or all of the aspects are defined in the dependent claims.

According to a first aspect, there is provided a method for a first device, such as a user equipment configured to communicate with a second user equipment over a sidelink channel, comprising: receiving a first radio transmission from a third device; determining, based on the received first radio transmission, at least one radio resource expected to be used for communication by the third device; determining a first direction from which the first radio transmission from the third device is received at the first device; determining a radio resource set based on the determined at least one radio resource and the determined first direction; and selecting one or more radio resources from the determined radio resource set for communication with a second device or transmitting the determined radio resource set to the second device or a network entity.

According to a second aspect, there is provided an apparatus, comprising one or more processors and memory comprising instructions which, when executed by the one or more processors, cause the apparatus to perform the method or an embodiment thereof.

According to some further aspects, there is provided an apparatus, comprising means for performing the method or an embodiment thereof. The means may comprise one or more processors and memory comprising instructions which, when executed by the one or more processors, cause the apparatus to perform the method.

The apparatus may be a user device or a terminal, such as a user equipment configured to access a 3GPP network, configured to communicate with another user equipment over a sidelink channel.

According to still further aspects, there is provided a computer program product, a computer readable medium, or a non-transitory computer readable medium comprising program instructions for causing, when executed in a processor of an apparatus, the apparatus to perform the method or an embodiment thereof.

### BRIEF DESCRIPTION OF THE DRAWINGS

FIG. 1 illustrates an example of a wireless communications system;

FIG. 2 illustrates a method in accordance with at least some embodiments;

FIGS. 3 to 7 illustrate some examples of 5G NR based sidelink communication; and

FIG. 8 illustrates an example apparatus capable of supporting at least some embodiments.

### DETAILED DESCRIPTION

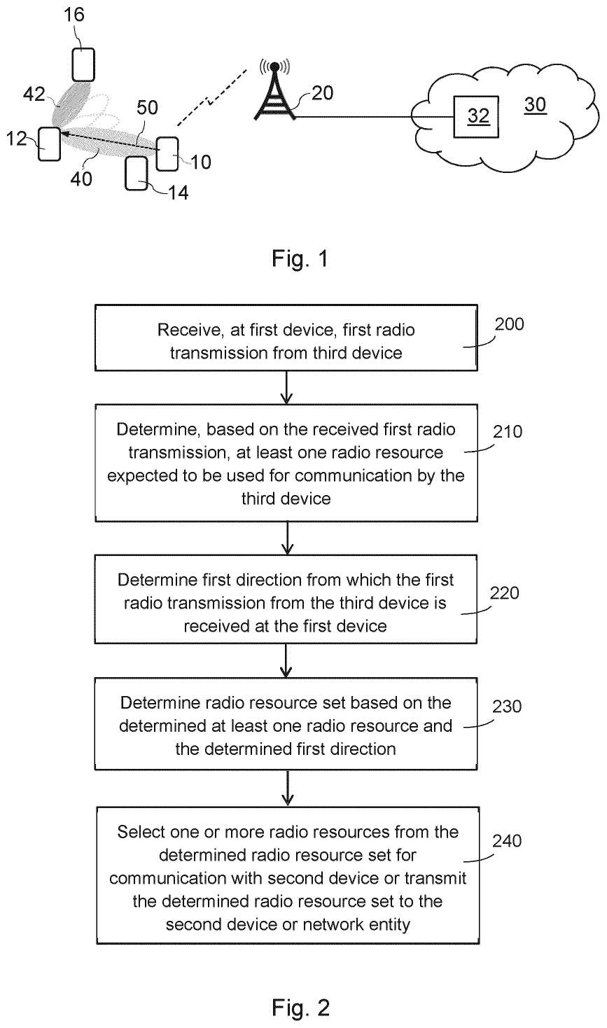

FIG. 1 illustrates a simplified example wireless communications system. A wireless communications device, herein referred to as a user equipment (UE) 10 may be configured to communicate wirelessly with a wireless radio or access network entity or node, hereafter also referred to as AN, 20, such as a NodeB, an evolved NodeB (eNB), a Next Generation (NG) NodeB (gNB), a base station, an access point, or other suitable wireless/radio access network (RAN) device or system.

The UE 10 may attach or register to the AN 20 for wireless communications. The air interface between UE and AN may be configured in accordance with a Radio Access Technology, RAT, which both the UE 10 and AN 20 are configured to support.

Examples of cellular RATs include Long Term Evolution, LTE, New Radio, NR, which is also known as fifth generation, 5G, and MulteFire. On the other hand, an example of a non-cellular RAT includes Wireless Local Area Network, WLAN. Principles of the present disclosure are not limited to a specific RAT though. For example, in the context of NR, AN 20 may be a gNB, but in the context of another RAT, AN 20 may be another type of base station, access node or NodeB.

The AN 20 may comprise one or more operationally and/or physically separate sub-units or nodes referred to below as nodes or logical RAN nodes. The controlling node 22 may be a central unit (CU) and the controlled node(s) may be distributed unit(s) (DU), such as the gNB-CU and gNB-DU connected over F1 interface of 5G RAN, respectively.

The AN 20 may be connected, directly or via at least one intermediate node, with one or more devices or elements 32 of a core network 30, such as a Next Generation core network, Evolved Packet Core (EPC), or other network management element(s). The core network 30 may comprise a set of network functions. A network function may refer to an operational and/or physical entity. The core network element 32 may be a network function or be configured to perform one or more network functions. The network function may be a specific network node or element, or a specific function or set of functions carried out by one or more entities, such as virtual network elements. Examples of such network functions include an access control or management function, mobility management or control function, session management or control function, interworking, data management or storage function, authentication function or a combination of one or more of these functions.

For example, a 5G core network comprises Access and Mobility Management Function (AMF) which may be configured to terminate RAN control plane (N2) interface and perform registration management, connection management, reachability management, mobility management, access authentication, access authorization, Security Anchor Functionality (SEAF), Security Context Management (SCM), and support for interface for non-3GPP access.

The UE 10 may be referred to as a user device or wireless terminal in general. Without limiting to 3GPP User Equipment, the term user equipment may be understood broadly to cover various mobile/wireless terminal devices, mobile stations and user devices for user communication and/or machine to machine type communication. The UE 10 may be or be comprised by, for example, a smartphone, a cellular phone, an Internet of Things (IoT) device, a wearable, a vehicle telemetry unit or another type of V2X device, a laptop computer, a tablet computer or, indeed, another kind of suitable user device or mobile station, i.e., a terminal.

Additionally, although the apparatuses have been depicted as single entities, different units, processors and/or memory units may be implemented inside these apparatuses, to enable the functioning thereof. The system may also be able to support the usage of cloud services, for example at least part of core network operations may be carried out as a cloud service. Edge cloud may be brought into radio access network (RAN) by utilizing network function virtualization (NVF) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. For example, in a 5G cloud RAN, the DU's server and relevant software could be hosted on a site itself or can be hosted in an edge cloud (datacenter or central office) depending on transport availability and fronthaul interface. One of the concepts for 5G networks is network slicing in which multiple independent and dedicated virtual sub-networks (network instances) may be created within the same infrastructure to run services that have different requirements on latency, reliability, throughput and mobility.

FIG. 1 further illustrates that the UE 10 may operate as a relay device to another UE 12, which may operate as remote device. Devices 10 and 12 may be terminal devices and referred to as relay terminal and remote terminal, respectively. Since the devices 10, 12 may be UEs, such as 5G UEs, they may also be referred to as relay UE/eRelay-UE and remote UE/eRemote-UE, respectively.

A sidelink (SL) may be established between the UE 10 and the UE 12 to provide U2N or U2U relayed communication. In case of NR, an NR SL over PC5 interface or a non-3GPP link may be established between the UE 10 and the UE 12. The remote UE 12 may be out of cell coverage or in cell coverage. The UEs 10, 12 may be in the same cell, in different cells, or even without radio network access when the SL is established.

In case of NR SL communication, SL data transmissions are performed in a physical sidelink shared channel (PSSCH). Radio resources for PSSCH transmissions may be scheduled in a centralized fashion by a base station (gNB), this mode of operation being referred to as Mode 1. In NR SL Mode 2, radio resources are selected autonomously by SL

UEs with the aid of a sensing procedure.

As part of Rel-17 NR SL enhancements, inter-UE coordination for Mode 2 resource allocation has been proposed. A set of radio resources is determined by a first UE, such as the UE 10. This set is signaled 50 to a second UE, such as the UE 12, and the second UE takes this set into account in the resource selection for its own sidelink transmission.

Sensing allows a UE to determine which radio resources are currently occupied or reserved in its proximity and is the basis for UE autonomous resource selection (Mode 2). Sensing is assumed to be omnidirectional in Rel-16/17 NR SL. Thus, a sensing UE has a 360° view of the radio environment. However, sensing and resource selection procedures designed on the basis of omnidirectional transmission/reception should be enhanced in order to take full advantage of beamforming. For example, UE 12 communicating by SL via beam 40 with UE 10 should avoid radio resources used by a transmitting UE 14, since UE 14 is located within or close to the beam and may therefore cause significant interference for the transmission of the UE 12 via the beam 40. However, radio resources used by UE 16 may not need to be avoided.

One possible way for a UE to determine the direction from which sensed SL transmissions reach the UE is to perform sensing within a beam. For example, the UE 12 may perform beam-based sensing on beam 40 to determine preferred or non-preferred radio resources for communicating with the UE 10. Similarly, the UE 12 may be configured to perform beam-based sensing on beam 42 to determine preferred or non-preferred radio resources for communicating with the UE 16.

However, it may be difficult, for example from a hardware complexity perspective, for a UE to perform sensing on multiple beams 40, 42 simultaneously. If beam-based sensing cannot be performed in parallel on more than one beam, then while sensing on one beam 40 the UE may be ‘blind’ on every other beam 42. Thus, this may compromise the ability of a UE 12 to establish beamformed SL communication with multiple correspondent UEs 10 and 16 simultaneously.

Another potential limitation of beam-based sensing is related to high UE mobility, for example in a V2X scenario. The interference geometry at the time of beam-based sensing and resource selection may change quickly due to high relative speed among UEs (that have aligned their beams and performed beam-based sensing) and/or other UEs in the area. Beam-based sensing under high UE mobility may thus lead to frequent resource reselection, especially under high load, degrading system performance.

There are now provided improvements for radio transmission sensing and radio resource selection, based on direction of sensed radio transmissions, in some embodiments based on estimated angle of arrival (AoA) of received radio transmissions.

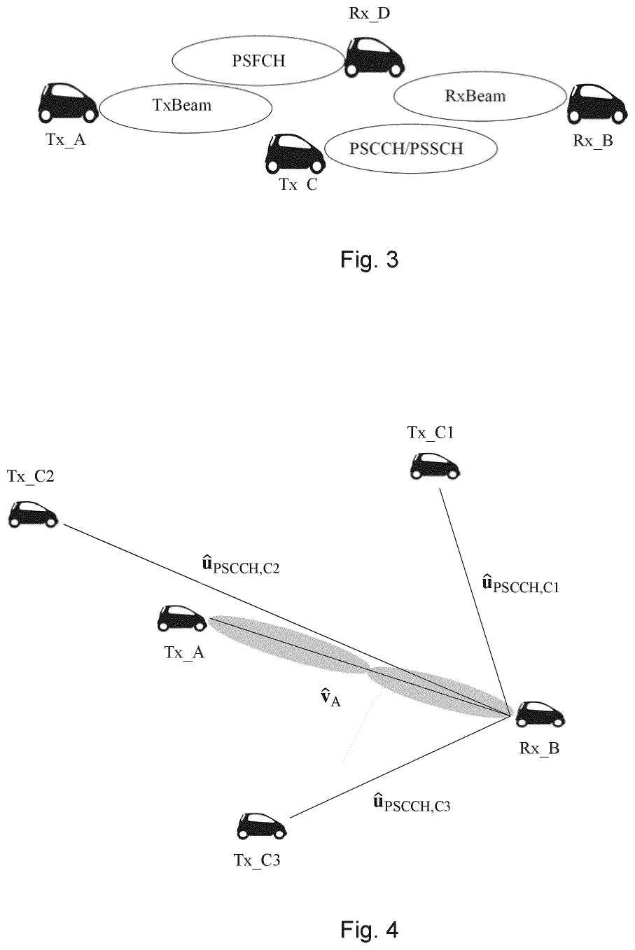

FIG. 2 is a flow graph of a method for facilitating radio resource selection, in accordance with at least some embodiments. The method may be performed in a first device for communicating with a second device. The method may be performed by an apparatus configured to control or at least affect radio resource selection, such as the UE 10, in some embodiments configured to operate as a SL user equipment, or by a control device configured to control the functioning thereof. It is to be noted that an action, such as transmitting, in a given block of any of the methods disclosed herein may refer to controlling or causing such action in another apparatus or unit.

Block 200 comprises receiving, at a first device, such as the UE 10, a first radio transmission from a third device, such as the UE 14 or UE 16.

Block 210 comprises determining, based on the received first radio transmission, at least one radio resource expected to be used for communication by the third device.

Block 220 comprises determining a first direction from which the first radio transmission from the third device is received at the first device.

Block 230 comprises determining a radio resource set based on the determined at least one radio resource and the determined first direction.

Block 240 comprises selecting one or more radio resources from the determined radio resource set for communication with a second device, such as the UE 12, or transmitting the determined radio resource set to the second device or a network entity, such as the AN 20, for example a base station or gNB. In the latter options, the apparatus performing the method may thus cause transmission of a message to the second device or the network entity for radio resource selection, the message being indicative of the determined radio resource set.

Block 210 may comprise decoding information in the first transmission indicative of radio resource(s) being reserved or otherwise indicated to be used by the third device. For example, this may include decoding sidelink control information (SCI) in an 5G NR SL transmission received from the third device, the SCI being indicative of such at least one radio resource expected to be used.

In some embodiments, determining 230 the radio resource set may comprise, or be preceded by, determining a set of candidate radio resources for communication with the second device. Block 230 may comprise determining or selecting (a subset of) radio resources from the set of candidate radio resources. Determining the set of candidate radio resources may be performed by the first device itself, or it may be based on radio resources indicated in a received message. Thus, there may be a further block, before block 230, of determining or receiving the set of candidate radio resources. When the first device is operating as a transmitting device, determining the set of candidate radio resources may comprise, or be preceded by, receiving the set of candidate radio resources from the second device as a receiving device. The transmitting first device may then in block 240 select the radio resource(s) and then transmit to the second device by using the selected radio resource(s). When the first device is operating as a receiving device, it may in block 240 transmit a message indicative to the second device (operating as a transmitting device) or the network entity, to select one or more radio resources for transmission from the second device to the first device.

Block 220 of determining the first direction may comprise estimating an angle of arrival (AoA) or direction of arrival (DoA) of the first radio transmission at the first device. The AoA or DoA may thus be indicative of an estimated angle (or direction) from which the first radio transmission is received at the first device with respect to a reference direction. This may be performed using any existing AoA or DoA estimation techniques. In some other embodiments, block 220 comprises determining a position of the third device relative to the first device. For example, this may be based on the exchange of sidelink positioning reference signals (SL PRS) or from position information available in higher layers (e.g., from cooperative awareness messages, CAM, or basic safety messages, BSM).

The determined radio resource set may comprise preferred or non-preferred radio resources for communication with the second device. Preferred radio resources may refer to radio resources among which a radio resource for the communication may be selected. In some case, a set of preferred radio resources may include radio resources recommended for the communication. Non-preferred radio resources may refer to radio resources that are excluded from (or not recommended for) selection for the communication. When the radio resource set is a set of non-preferred radio resources, the first device may determine radio resources into the set directly based on resource reservation indications of other (third) devices (instead of determining them from a set of candidate resources).

In some embodiments, the apparatus performing the method of FIG. 2 is further configured to determine a second direction from which a second radio transmission from the second device is received at the first device. This may be an additional block preceding block 220, before or after block 220. The second radio transmission may be associated with inter-device coordination between the first device and the second device. The second direction may be determined based on estimating an angle of arrival of the second radio transmission at the first device, or based on determining a position of the second device relative to the first device.

Determining the radio resource set in block 230 may thus further be based on the determined second direction. An angular distance (or angular separation) between the determined first direction and the determined second direction may be determined. For example, the apparatus may be configured to determine whether a candidate radio resource at least partially overlaps with a radio resource reserved by the first radio transmission. If such candidate radio resource at least partially overlaps with the reserved radio resource and the determined angular distance is below a threshold value, it may be excluded from the set of candidate radio resources when determining a preferred resource set. Alternatively, the apparatus may be configured to determine as non-preferred a radio resource if it is indicated as reserved by the first radio transmission and the determined angular distance is below a threshold value. Such non-preferred radio resource may be included in a radio resource set indicative of non-preferred radio resources. The threshold value may be preconfigured or determined based on a transmit antenna beamwidth and/or receive antenna beamwidth to be used for communication with the second device, for example.

In some embodiments, the apparatus is configured to estimate a (future) direction from which an expected (future) radio transmission from another device, such as the third device, is expected to be received at the first device. Such expected transmission from the third device may be referred to as a third transmission and the associated direction as third direction. Similarly, the apparatus may be configured to estimate a (future) direction of expected (future) communication (transmission or reception) with the second device (which may be referred to as fourth direction and fourth transmission). Velocity of the respective devices may be defined or measured to estimate the expected future directions. The directions may be estimated based on estimated relative motion of the respective devices.

The apparatus may be configured to determine the radio resource set based on the third direction(s) and/or fourth direction(s). It will be appreciated that the apparatus may estimate a sequence of expected (third) directions of radio transmissions to be received from the third device and/or a sequence of expected (fourth) directions of radio transmissions to be transmitted to or received from the second device and apply the sequence(s) of directions to determine the radio resource set. In some embodiments, the apparatus determines a second angular distance between the third direction and the fourth direction and the radio resource set is determined based on the second angular distance. The apparatus may determine a radio resource to be non-preferred at least if it is indicated as reserved by the first radio transmission and the determined second angular distance is below a threshold. In an embodiment, when determining a preferred resource set, the apparatus may exclude a candidate radio resource from the set of candidate radio resources at least if it overlaps, at least partially, with a radio resource indicated as reserved by the first radio transmission and the determined second angular distance is below a threshold value.

The apparatus may then select one or more radio resources from the determined radio resource set for communication with the second device or transmit the determined radio resource set to the second device or a network entity.

The apparatus may be configured to define and process further input parameter(s) to determine 230 the radio resource set. In some embodiments, further properties of received radio transmissions and associated threshold value(s) are applied. For example, measured signal strength values are compared to a threshold value as precondition for selecting to the radio resource set. In another example embodiment, distance(s) of the first device to the third device(s) are estimated and compared to a threshold value as precondition for selecting to the radio resource set.

In some embodiments, at least some of the presently disclosed features are applied for 5G NR SL communications, some further such example embodiments being illustrated below with references to NR SL entities and channels, without limiting application of the illustrated features to NR SL communications. Thus, the apparatus may be configured to perform a NR SL UE physical layer entity. The physical layer entity may be configured to perform physical layer procedures of SL data channels as defined in 3GPP specification 38.214 (current version 16.7.0), section 8.

Before a physical sidelink control channel/physical sidelink shared channel (PSCCH/PSSCH) transmission may take place from a transmitter UE (Tx_A) to a receiver UE (Rx_B), sensing and resource selection may be jointly performed by the UEs.

In order for a SL UE to perform sensing and obtain necessary information to receive a SL transmission, it decodes SCI. The SCI associated with a data transmission may include a 1^{st}-stage SCI and 2^{nd}-stage SCI. The NR SCI contents are specified in 3GPP TS 38.212.

One inter-UE coordination scenario, in which at least some of the presently disclosed features may be used, is when a SL receiver UE (Rx_B) determines and conveys its preferred or non-preferred resources to a SL transmitter UE (Tx_A). The transmitter UE may take into account the resource(s) indicated by the receiver UE, in addition to performing its own sensing. Such scenario is also denoted as Inter-UE Coordination Scheme 1 in NR SL specifications. This may be used, for example, as a means to address the hidden node problem, whereby the receiver UE is exposed to interference sources not detectable by the transmitter UE.

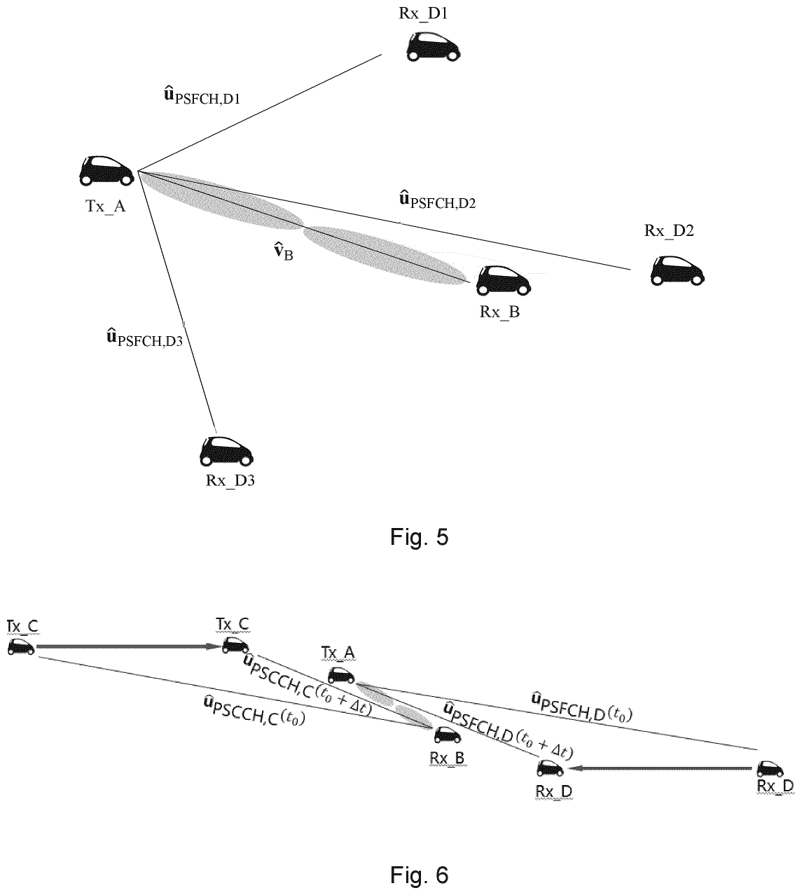

FIG. 3 illustrates a simple example of NR SL based communication scenario. A receiver UE (Rx_B) may operate as the first device of the method of FIG. 2 and determine a set of preferred or non-preferred radio resources to be used by a corresponding transmitter UE (Tx_A) operating as the second device. The receiver UE may determine the set based on a determined direction of a received PSCCH/PSSCH transmission (the first radio transmission) from a third UE (Tx_C) operating as the third device. Similar notations are applied also in subsequent examples. Alternatively, or additionally, the receiver UE may determine the set based on a predicted direction of an expected PSCCH/PSSCH transmission by the third UE (Tx_C). The receiver UE may report the set to the transmitter UE (Tx_A), which may then select a transmission resource from the received set.

Similarly, a transmitter UE (Tx_A) may deprioritize or exclude from resource selection for its own transmission a candidate radio resource based on a determined direction of a received physical sidelink feedback channel (PSFCH) transmission from a further UE, which may also be a “third device”, such as the UE Rx_D. The UE(s), such as the transmitter UE (Tx_A), may also be configured to predict a direction of an expected transmission, such as a PSFCH transmission expected from the UE Rx_D, and to determine the set based on the predicted direction.

In another embodiment, the transmitter UE (Tx_A) determines a set of preferred or non-preferred resources for a PSCCH/PSSCH transmission. The transmitter UE may then report the set to the receiver UE (Rx_B). The receiver UE may then select a transmission resource from the received set and inform the transmitter UE (Tx_A) of the selected resource.

In general, both the determination of the radio resource set, by the transmitter UE or receiver UE, and the subsequent resource selection from the set (by the receiver UE or transmitter UE, respectively) may be based on local sensing of prior radio transmissions, such as PSCCH/PSSCH or PSFCH transmissions, in the radio proximity of the respective UE.

An example of resource selection for SL communications at a receiver UE is illustrated with reference to FIG. 4. The receiver UE (Rx_B) may perform sensing and decode PSCCH transmitted by third UE(s), such as one or more of UEs Tx_C1, Tx_C2, and Tx_C3. The receiver UE (Rx_B) may determine 220 a first direction û_{PSCCH} (unit vector) associated with a decoded PSCCH. For example, the receiver UE (Rx_B) may determine the first direction û_{PSCCH} by estimating an AoA or DoA of the PSCCH transmission as it arrives at the receiver UE (Rx_B).

In another example embodiment, the receiver UE (Rx_B) may determine 220 the first direction û_{PSCCH} based on a determined position of the third UE (Tx_C1, Tx_C2, Tx_C3) relative to the receiver UE (Rx_B).

The receiver UE (Rx_B) may then determine 230 a set of preferred or non-preferred resources to be used by the transmitter UE (Tx_A), based on the determined first direction û_{PSCCH}. In another embodiment, the receiver UE may determine a set of radio resources or select a resource to be used by the transmitter UE (Tx_A) from a received set of radio resources, based on the determined first direction û_{PSCCH}.

In some embodiments, the receiver UE (Rx_B) may determine a second direction \hat{v}_{A}, which may correspond to the line-of-sight (LOS) towards the transmitter UE (Tx_A). Similar to the first direction û_{PSCCH}, the second direction \hat{v}_{A} may be determined by the receiver UE (Rx_B) by estimating an angle of arrival (AoA) or direction of arrival (DoA) of a radio transmission from the transmitter UE (Tx_A). For example, the AoA or DoA may be estimated based on a radio transmission used by the transmitter UE (Tx_A) to convey its coordination request. In another embodiment, the second direction \hat{v}_{A} is determined based on a determined position of the transmitter UE (Tx_A) relative to the receiver UE (Rx_B).

To determine 230 the set, the receiver UE may compare the first direction û_{PSCCH} to the second direction \hat{v}_{A}. If the first direction û_{PSCCH} is sufficiently different from the second direction \hat{v}_{A}, the receiver UE (Rx_B) may ignore the associated decoded PSCCH when determining the set of preferred or non-preferred resources, or selecting the resource to be used by the transmitter UE (Tx_A). For example, this may be the case when the angular distance Δ=cos⁻¹(û_{PSCCH} ·\hat{v}_{A}) between the first and second directions is greater than a predefined or configured threshold Δₜₕ (i.e., Δ>Δₜₕ). The predefined or configured threshold Δₜₕ may be UE-specific. For example, the threshold Δₜₕ may be based on a UE capability, such as a (half-power) beamwidth Ψ of the receiver UE's receive antenna (i.e., main lobe). For example, if ψ=50° and Δₜₕ=ψ/2, then PSCCH decoded with an associated angular distance Δ>25° may be ignored.

The decision whether or not to ignore a decoded PSCCH in the resource selection procedure may also be based on a measured signal strength, for example a reference signal received power (RSRP) of the received PSCCH/PSSCH transmission or a determined distance to the third UE (Tx_C1, Tx_C2, Tx_C3). For example, if the signal strength is high and above an associated RSRP threshold value, the receiver UE (Rx_B) may decide not to ignore the received PSCCH even if the associated angular distance Δ is above the threshold Δₜₕ. In this way, the effect of sidelobes in the receive antenna pattern of the receiver UE (Rx_B) may be taken into account.

On the other hand, if the first direction û_{PSCCH} is sufficiently similar to the second direction \hat{v}_{A}, the receiver UE (Rx_B) may take into account the associated decoded PSCCH when determining the set of preferred or non-preferred resources, or selecting the resource to be used by the transmitter UE (Tx_A). The receiver UE may be configured to include the PSCCH when the angular distance Δ=cos⁻¹(û_{PSCCH} ·\hat{v}_{A}) between the first and second directions is smaller than the threshold Δₜₕ, i.e., Δ<Δₜₕ. For example, the receiver UE (Rx_B) may exclude from a preferred resource set a candidate resource if it overlaps at least partially with a resource indicated by the decoded PSCCH and Δ<Δₜₕ.

For example, as illustrated in Error! Reference source not found.4, the PSCCH decoded from certain transmitters (Tx_C1, Tx_C3) may be associated with a determined first direction (û_{PSCCH,C1}, û_{PSCCH,C3}) significantly far apart from the determined second direction (\hat{v}_{A}), which may result in Δ>Δₜₕ. If receive beamforming is applied by the receiver UE (Rx_B) when receiving from the transmitter UE (Tx_A), such transmitters (Tx_C1, Tx_C3) may not cause any significant interference at the receiver UE (Rx_B) despite their physical proximity to the receiver UE (Rx_B). Thus, the resources reserved by such transmitters (Tx_C1, Tx_C3) may not need to be excluded from resource selection or indicated as non-preferred by the receiver UE (Rx_B). On the other hand, the PSCCH decoded from other transmitters (Tx_C2) may be associated with a determined first direction (û_{PSCCH,C2}) very close to the determined second direction (\hat{v}_{A}), which may result in Δ<Δₜₕ. Even if receive beamforming is applied by the receiver UE (Rx_B) when receiving from the transmitter UE (Tx_A), such other transmitters (Tx_C2) may cause significant interference at the receiver UE (Rx_B). Thus, the resources reserved by such other transmitters (Tx_C2) may need to be excluded from resource selection or indicated as non-preferred by the receiver UE (Rx_B).

A specific advantage of direction aware resource exclusion is that fewer resources may be excluded from resource selection or indicated as non-preferred by the receiver UE (Rx_B). This facilitates to increase spatial reuse of radio resources across the SL network, and consequently network capacity.

FIG. 5 illustrates an example of PSFCH AoA based resource selection at a transmitter UE. The transmitter UE (Tx_A) may perform sensing of PSFCH transmission(s) from at least one third UE (one or more of Rx_D1, Rx_D2, Rx_D3). The transmitter UE (Tx_A) may determine a first direction û_{PSFCH} associated with a sensed PSFCH. For example, the transmitter UE (Tx_A) may determine the first direction û_{PSFCCH} by estimating an angle of arrival (AoA) or direction of arrival (DoA) of the PSFCH transmission as it arrives at the transmitter UE (Tx_A). Alternatively, the transmitter UE (Tx_A) may determine the first direction û_{PSFCH} based on a determined position of the third UE (Rx_D1, Rx_D2, Rx_D3) relative to the transmitter UE (Tx_A).

The transmitter UE (Tx_A) may then determine a set of preferred or non-preferred resources for its transmission to the receiver UE (Rx_B), based on the determined first direction û_{PSFCH}. In another embodiment, the transmitter UE may determine a set of radio resources or select a resource for its transmission to the receiver UE (Rx_B) from a received set. For example, the transmitter UE (Tx_A) may compare the first direction û_{PSFCH} with a second direction \hat{v}_{B}, e.g., corresponding to the LOS towards the receiver UE (Rx_B). Similar to the first direction û_{PSFCH}, the second direction \hat{v}_{B} may be determined by the transmitter UE (Tx_A) by estimating an angle of arrival (AoA) or direction of arrival (DoA) of a radio transmission from the receiver UE (Rx_B). For example, the AoA or DoA may be estimated based on a radio transmission used by the receiver UE (Rx_B) to convey its coordination message. In another embodiment, the second direction \hat{v}_{B} is determined based on a determined position of the receiver UE (Rx_B) relative to the transmitter UE (Tx_A).

To determine 230 the set, the transmitter UE may compare the first direction û_{PSFCH} to the second direction \hat{v}_{B}. If the first direction û_{PSFCH} is sufficiently different from the second direction \hat{v}_{B}, the transmitter UE (Tx_A) may ignore the associated sensed PSFCH when determining the set of preferred or non-preferred resources, or selecting the resource to be used for its transmission to the receiver UE (Rx_B). For example, this may be the case when the angular distance Δ=cos⁻¹(û_{PSFCH} ·\hat{v}_{B}) between the first and second directions is greater than a predefined or configured threshold Δₜₕ, i.e., Δ>Δₜₕ. The predefined or configured threshold Δₜₕ may be UE-specific. For example, the threshold Δₜₕ may be based on a UE capability, such as a (half-power) beamwidth ψ of the transmitter UE's transmit antenna (i.e., main lobe). For example, if ψ=50° and Δₜₕ=ψ/2, then PSFCH sensed with an associated angular distance Δ>25° may be ignored.

The decision whether or not to ignore a sensed PSFCH in the resource selection procedure may further be based on a measured signal strength of the received PSFCH transmission or a determined distance to the third UE (Rx_D1, Rx_D2, Rx_D3). For example, if the signal strength is high and above an associated threshold value, the transmitter UE (Tx_A) may decide not to ignore the sensed PSFCH even if the associated angular distance Δ is above the threshold Δₜₕ. In this way, the effect of sidelobes in the transmit antenna pattern of the transmitter UE (Tx_A) may be taken into account.

On the other hand, if the first direction û_{PSFCH} is sufficiently similar to the second direction \hat{v}_{B}, the transmitter UE (Tx_A) may take into account the associated sensed PSFCH when determining the set of preferred or non-preferred resources, or selecting the resource to be used for its transmission to the receiver UE (Rx_B). This may be the case, for example, if the angular distance Δ=cos⁻¹(û_{PSFCH}·\hat{v}_{B}) between the first and second directions is smaller than the threshold Δₜₕ, i.e., Δ<Δₜₕ. For example, the transmitter UE (Tx_A) may determine, based on the sensed PSFCH, a resource in which the third UE (Rx_D1, Rx_D2, Rx_D3) is expected to receive. The transmitter UE may deprioritize or exclude from resource selection for its transmission to the receiver UE (Rx_B) a candidate resource which overlaps at least partially with the determined resource.

For example, as illustrated in FIG. 5, the PSFCH sensed from certain receivers (Rx_D1, Rx_D3) may be associated with a determined first direction (û_{PSFCH,D1}, û_{PSFCH,D3}) significantly far apart from the determined second direction (\hat{v}_{B}), which may result in Δ>Δₜₕ. If transmit beamforming is applied by the transmitter UE (Tx_A) when transmitting to the receiver UE (Rx_B), such receivers (Rx_D1, Rx_D3) may not suffer any significant interference from the transmitter UE (Tx_A) despite their physical proximity to the transmitter UE (Tx_A). Thus, resources reserved for transmission to such receivers (Rx_D1, Rx_D3) may not need to be excluded from resource selection or indicated as non-preferred by the transmitter UE (Tx_A). Under the assumption of periodic resource reservation (i.e., for semi-persistent transmission), the resources reserved for transmission to such receivers (Rx_D1, Rx_D3) may be determined, at least in part, by the transmitter UE (Tx_A) from respective, consecutively sensed PSFCH transmissions through reverse PSFCH-to-PSSCH resource mapping. On the other hand, the PSFCH sensed from other receivers (Rx_D2) may be associated with a determined first direction (û_{PSFCH,D2}) very close to the determined second direction (\hat{v}_{B}), which may result in Δ<Δₜₕ. Even if transmit beamforming is applied by the transmitter UE (Tx_A) when transmitting to the receiver UE (Rx_B), such other receivers (Rx_D2) may suffer significant interference from the transmitter UE (Tx_A). Thus, the resources reserved for transmission to such other receivers (Rx_D2) may need to be excluded from resource selection or indicated as non-preferred by the transmitter UE (Tx_A).

A specific advantage with respect to sensing of PSFCH transmissions without direction awareness is that fewer resources may be excluded from resource selection or indicated as non-preferred by the transmitter UE (Tx_A). This facilitates to increase spatial reuse of radio resources across the SL network, and consequently network capacity.

### Predictive Resource Selection

In V2X, UEs may be subject to high mobility, such as relative velocity. In some embodiments, the set of radio resources for SL communication is determined based on predicted directions of transmissions from the third device and/or the second device. This facilitates to minimize disruption to and/or from nearby radio transmissions and/or to avoid the need for resource reselection (e.g., during an ongoing communication session) due to the rapidly changing interference geometry (potentially leading to resource reselection by other UEs further away and creating a chain reaction that might degrade system performance).

A receiver UE (Rx_B) and/or a transmitter UE (Tx_A) may be configured to predict a sequence of receive directions \hat{v}_{A,1}, . . . , \hat{v}_{A,n} and/or transmit directions \hat{v}_{B,1}, . . . , \hat{v}_{B,n}, respectively, to be “visited” within a time interval. The directions may be predicted from received or determined position and/or velocity information, for example. Such prediction can then be used to exclude from resource selection, or indicate as non-preferred, a larger set of resources than would be excluded, or indicated as non-preferred, if only the initial receive/transmit direction (\hat{v}_{A,1}, \hat{v}_{B,1}) at the time of resource selection were taken into account.

The interference geometry might change even if the transmitter UE (Tx_A) and receiver UE (Rx_B) do not move relative to each other. For example, in a scenario illustrated in Error! Reference source not found., the transmitter UE (Tx_A) and the receiver UE (Rx_B) are assumed, for simplicity, to travel at a same speed (e.g., 120 km/h at a highway), while a further transmitter UE (Tx_C) travels faster (e.g., 160 km/h) and a further receiver UE (Rx_D) travels slower (e.g., 80 km/h). Surrounding UEs (Tx_C, Rx_D) may thus enter a receive beam or transmit beam during a connection, potentially causing (Tx_C) or suffering (Rx_D) interference. Thus, sequence(s) of (third) directions of expected (third) transmissions from the surrounding UE(s) may be estimated and the set determined based on the sequence(s).

For example, at time t₀, Rx_B receives PSCCH from Tx_C with an associated determined direction û_{PSCCH,C}(t₀). If Tx_C transmits PSCCH periodically at time instances tₖ, given its faster speed, Rx_B will observe subsequent PSCCH from Tx_C at slightly different directions û_{PSCCH,C}(tₖ). The directions û_{PSCCH,C}(tₖ) may be determined by Rx_B based on AoA/DoA estimation and/or based on received or determined position and/or velocity information of Tx_C. Based on the determined directions û_{PSCCH,C}(tₖ), Rx_B may predict a future direction û_{PSCCH,C}(t₀+Δt) such that cos⁻¹(û_{PSCCH,C}(t₀+Δt)·\hat{v}_{A})<Δₜₕ. Rx_B may thus predict that Tx_C will approach into its receive beam shortly. Based on such prediction, Rx_B may indicate as non-preferred any resource reserved for periodic transmission by Tx_C, even though at the time of resource selection, e.g., at t₀, Tx_C is outside of Rx_B's receive beam.

Similarly, at time t₀, Tx_A receives PSFCH from Rx_D with an associated determined direction û_{PSFCH,D}(t₀). If Rx_D transmits PSFCH periodically at time instances tₖ, given its slower speed, Tx_A will observe subsequent PSFCH from Rx_D at slightly different directions û_{PSFCH,D}(tₖ). The directions û_{PSFCH,D}(tₖ) may be determined by Tx_A based on AoA/DoA estimation and/or based on received or determined position and/or velocity information of Rx_D. Based on the determined directions û_{PSFCH,D}(tₖ), Tx_A may predict a future direction û_{PSFCH,D}(t₀+Δt) such that cos⁻¹(û_{PSFCH,D}(t₀+Δt)·\hat{v}_{B})<Δₜₕ. Tx_A may thus predict that Rx_D will approach into its transmit beam shortly. Based on such prediction, Tx_A may exclude from resource selection for its transmission to Rx_B any candidate resource overlapping with a resource in which Rx_D is expected to receive, even though at the time of resource selection, e.g., at to, Rx_D is outside of Tx_A's transmit beam.

In another example, as illustrated in FIG. 7, instead of or in addition to relative motion of surrounding (third) UEs (such as Tx_C), the transmitter UE (Tx_A) and receiver UE (Rx_B) may be in motion relative to one another, e.g., traveling at different speeds. Thus, a sequence of (fourth) directions of expected (fourth) transmissions to or from the peer SL UE (second device) may be estimated and the set may be determined further based on the sequence. Thus, future interference geometry may be predicted in case of relative motion between transmitter UE (Tx_A) and receiver UE (Rx_B) as well as relative motion of interference sources (Tx_C).

For example, the receiver UE (Rx_B) may indicate as non-preferred (or exclude from its resource selection) a resource reserved by a decoded PSCCH from a third UE (Tx_C) if cos⁻¹(û_{PSCCH,C}(t)·\hat{v}_{A}(t)<Δₜₕ for any instant t₀≤t≤t₁. The time interval [t₀, t₁] may be understood as a minimum period of time during which no resource reselection should occur. For example, this may be an expected duration of an overtake maneuver or sensor data exchange.

Similarly, the transmitter UE (Tx_A) may exclude from its resource selection (or indicate as non-preferred) a candidate resource that overlaps with a resource in which a third UE (Rx_D) is expected to (periodically) receive, based on sensed PSFCH transmissions from the third UE (Rx_D), if cos⁻¹(û_{PSFCH,D}(t)·\hat{v}_{B}(t)<Δₜₕ for any instant to t₀≤t≤t₁.

An electronic device comprising electronic circuitries may be an apparatus for realizing at least some embodiments of the present invention. The apparatus may be or may be comprised in a computer, a user/terminal device, such as a V2X device, or another apparatus capable for at least controlling RRC level data transmission. In another embodiment, the apparatus carrying out at least some of the above-described functionalities is comprised in such a device, e.g., the apparatus may comprise a circuitry, such as a chip, a chipset, a microcontroller, or a combination of such circuitries in any one of the above-described devices.

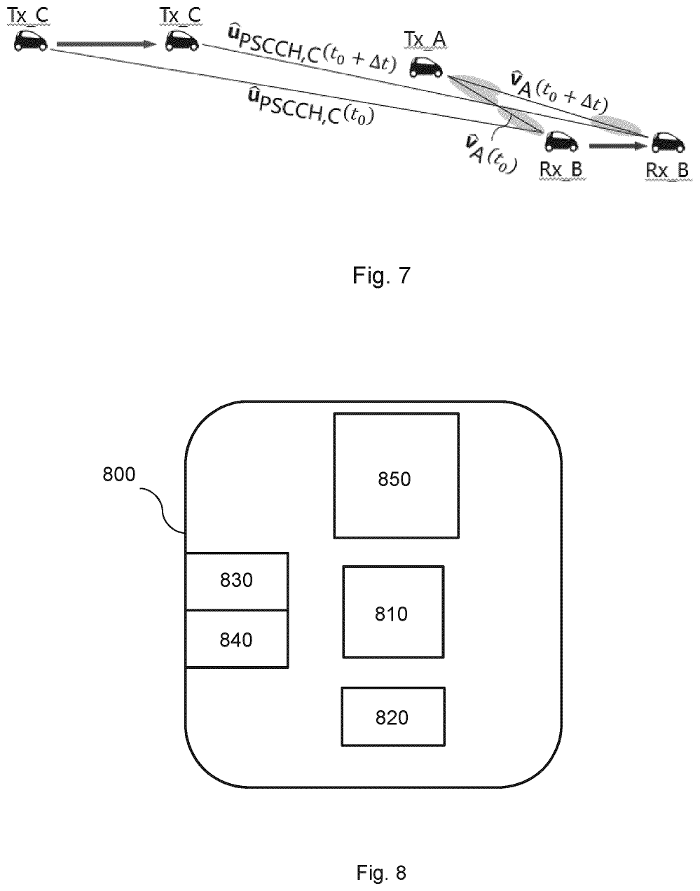

FIG. 8 illustrates an example apparatus capable of supporting at least some embodiments. Illustrated is device 800, which may comprise, for example, in applicable parts, a physical device operating as or controlling the transmitting and/or first device, such as the UE 10, for example. The device may be configured to operate as the apparatus performing the method of FIG. 2, or an embodiment thereof.

Comprised in device 800 is processor 810, which may comprise, for example, a single-or multi-core processor wherein a single-core processor comprises one processing core and a multi-core processor comprises more than one processing core. Processor 810 may comprise, in general, a control device. Processor 810 may comprise more than one processor. Processor 810 may be a control device. Processor 810 may comprise at least one application-specific integrated circuit, ASIC. Processor 810 may comprise at least one field-programmable gate array, FPGA. Processor 810 may be means for performing method steps in device 800, such as receiving, transmitting and/or providing, for example. Processor 810 may be configured, at least in part by computer instructions, to perform actions.

A processor may comprise circuitry, or be constituted as circuitry or circuitries, the circuitry or circuitries being configured to perform phases of methods in accordance with embodiments described herein. As used in this application, the term “circuitry” may refer to one or more or all of the following: (a) hardware-only circuit implementations, such as implementations in only analogue and/or digital circuitry, and (b) combinations of hardware circuits and software, such as, as applicable: (i) a combination of analogue and/or digital hardware circuit(s) with software/firmware and (ii) any portions of hardware processor(s) with software (including digital signal processor(s)), software, and memory (ies) that work together to cause an apparatus, such as a server, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 800 may comprise memory 820. Memory 820 may comprise random-access memory and/or permanent memory. Memory 820 may comprise at least one RAM chip. Memory 820 may comprise solid-state, magnetic, optical and/or holographic memory, for example. Memory 820 may be at least in part accessible to processor 810. Memory 820 may be at least in part comprised in processor 810. Memory 820 may be means for storing information. Memory 820 may comprise computer instructions that processor 810 is configured to execute. When computer instructions configured to cause processor 810 to perform certain actions are stored in memory 820, and device 800 overall is configured to run under the direction of processor 810 using computer instructions from memory 820, processor 810 and/or its at least one processing core may be considered to be configured to perform said certain actions. Memory 820 may be at least in part comprised in processor 810. Memory 820 may be at least in part external to device 800 but accessible to device 800.

Device 800 may comprise a transmitter 830. Device 800 may comprise a receiver 840. Transmitter 830 and receiver 840 may be configured to transmit and receive, respectively, information in accordance with at least one cellular or non-cellular standard. Transmitter 830 may comprise more than one transmitter. Receiver 840 may comprise more than one receiver. Transmitter 830 and/or receiver 840 may be configured to operate in accordance with a suitable messaging protocol.

Device 800 may comprise user interface, UI, 850. UI 850 may comprise at least one of a display, a keyboard and a touchscreen. A user may be able to operate device 800 via UI 850, for example to configure operating parameters stored in the memory 820, such as parameter affecting an operation of the above described method or an embodiment thereof.

Processor 810 may be furnished with a transmitter arranged to output information from processor 810, via electrical leads internal to device 800, to other devices comprised in device 800. Such a transmitter may comprise a serial bus transmitter arranged to, for example, output information via at least one electrical lead to memory 820 for storage therein. Alternatively, to a serial bus, the transmitter may comprise a parallel bus transmitter. Likewise, processor 810 may comprise a receiver arranged to receive information in processor 810, via electrical leads internal to device 800, from other devices comprised in device 800. Such a receiver may comprise a serial bus receiver arranged to, for example, receive information via at least one electrical lead from receiver 840 for processing in processor 810. Alternatively, to a serial bus, the receiver may comprise a parallel bus receiver. Device 800 may comprise further devices not illustrated in FIG. 8. In some embodiments, device 800 lacks at least one device described above.

Processor 810, memory 820, transmitter 830, receiver 840 and/or UI 850 may be interconnected by electrical leads internal to device 800 in a multitude of different ways. For example, each of the aforementioned devices may be separately connected to a master bus internal to device 800, to allow for the devices to exchange information. However, as the skilled person will appreciate, this is only one example and depending on the embodiment various ways of interconnecting at least two of the aforementioned devices may be selected without departing from the scope of the present invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention as defined by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

1-44. (canceled)

45. A first device, comprising:
one or more processors and memory comprising instructions which, when executed by the one or more processors, cause the first device to perform to:
receive, at the first device, a first radio transmission from a third device;
determine, based on the received first radio transmission, at least one radio resource to be used for communication by the third device;
determine a first direction from which the first radio transmission from the third device is received at the first device;
determine a radio resource set based on the determined at least one radio resource and the determined first direction; and
select one or more radio resources from the determined radio resource set for communication with a second device or transmitting the determined radio resource set to the second device or a network entity.

46. The first device of claim 45, wherein determining the radio resource set comprises determining a set of candidate radio resources for communication with the second device; and
wherein the determined radio resource set comprises preferred or non-preferred radio resources for communication with the second device.

47. The first device of claim 45, wherein the first device is configured to perform at least one of: select the one or more radio resources for transmission from the first device to the second device, or transmit a message indicative of the determined radio resource set to the second device or the network entity to select one or more radio resources for transmission from the second device to the first device.

48. The first device of claim 45, wherein determining the first direction comprises:
estimating an angle of arrival of the first radio transmission at the first device; or
determining a position of the third device relative to the first device.

49. The first device of claim 45, wherein the first device is caused to determine a second direction from which a second radio transmission from the second device is received at the first device, and wherein determining the radio resource set is further based on the determined second direction.

50. The first device of claim 49, wherein the second radio transmission is associated with inter-device coordination between the first device and the second device.

51. The first device of claim 49, wherein determining the second direction comprises estimating an angle of arrival of the second radio transmission at the first device or determining a position of the second device relative to the first device.

52. The first device of claim 49, wherein determining the radio resource set comprises determining a first angular distance between the determined first direction and the determined second direction.

53. The first device of claim 52, wherein the first device is caused to determine a radio resource to be non-preferred at least if the radio resource is indicated as reserved by the first radio transmission and the determined first angular distance is below a threshold value.

54. The first device of claim 52, wherein the radio resource set comprises preferred radio resources for communication with the second device and wherein determining the radio resource set comprises excluding a candidate radio resource from the set of candidate radio resources if:
the candidate radio resource overlaps, at least partially, with a radio resource indicated as reserved by the first radio transmission, and
the determined first angular distance is below a threshold value.

55. The first device of claim 52, wherein the first device is further caused to determine, based on the first radio transmission, a radio resource in which the third device is expected to receive, and wherein determining the radio resource set comprises deprioritizing or excluding a candidate radio resource from the set of candidate radio resources if:
the candidate radio resource overlaps, at least partially, with the determined radio resource in which the third device is expected to receive, and
the determined first angular distance is below a threshold value.

56. The first device of claim 55, wherein the first device is further caused to configure the threshold value based on at least one of a transmit antenna beamwidth or receive antenna beamwidth to be used for communication with the second device.

57. The first device of claim 45, wherein the first device is further caused to estimate a third direction from which a third radio transmission from the third device is expected to be received at the first device, and determine the radio resource set further based on the estimated third direction.

58. The first device of claim 45, wherein the first device is further caused to estimate a fourth direction associated with a fourth radio transmission expected to be transmitted to or received from the second device, and determine the radio resource set further based on the estimated fourth direction.

59. The first device of claim 45, wherein determining the radio resource set comprises determining a second angular distance between the estimated third direction and the estimated fourth direction.

60. The first device of claim 59, wherein the first device is caused to determine a radio resource to be non-preferred at least if the radio resource is indicated as reserved by the first radio transmission and the determined second angular distance is below a threshold value.

61. The first device of claim 59, wherein the radio resource set comprises preferred radio resources for communication with the second device and wherein determining the radio resource set comprises excluding a candidate radio resource from the set of candidate radio resources if:
the candidate radio resource overlaps, at least partially, with a radio resource indicated as reserved by the first radio transmission, and
the determined second angular distance is below a threshold value.

62. The first device of claim 59, wherein the first device is further caused to determine, based on the first radio transmission, a radio resource in which the third device is expected to receive, and wherein determining the radio resource set comprises deprioritizing or excluding a candidate radio resource from the set of candidate radio resources if:
the candidate radio resource overlaps, at least partially, with the determined radio resource in which the third device is expected to receive, and
the determined second angular distance is below a threshold value.

63. The first device of claim 45, wherein the first device is a user equipment configured to communicate with the second device, which is a user equipment, by a sidelink transmission, and wherein the first radio transmission is a physical sidelink control channel transmission, a physical sidelink shared channel transmission, or a physical sidelink feedback channel transmission.

64. A method, comprising:
receiving a first radio transmission from a third device;
determining, based on the received first radio transmission, at least one radio resource expected to be used for communication by the third device;
determining a first direction from which the first radio transmission from the third device is received at the first device;
determining a radio resource set based on the determined at least one radio resource and the determined first direction; and
selecting one or more radio resources from the determined radio resource set for communication with a second device or transmitting the determined radio resource set to the second device or a network entity.
